(19) United States
(12) Patent Application Publication
(10) Pub. No.: US 2023/0006338 A1
(43) Pub. Date: Jan. 5, 2023

(54) ELECTRONIC DEVICE AND WEARABLE DEVICE

(71) Applicant: GUANGDONG OPPO MOBILE TELECOMMUNICATIONS COPR., LTD., Dongguan (CN)

(72) Inventor: Enfu LIU, Dongguan (CN)

(21) Appl. No.: 17/929,953

(22) Filed: Sep. 6, 2022

Related U.S. Application Data
(63) Continuation of application No. PCT/CN2021/075014, filed on Feb. 3, 2021.

(30) Foreign Application Priority Data
Apr. 3, 2020 (CN) 202010258378.7

(51) Int. Cl. H01Q 1/27; H01Q 1/22; H01Q 1/38; G04G 21/04; G04G 17/04

(52) U.S. Cl. CPC H01Q 1/273; H01Q 1/22; H01Q 1/38; G04G 21/04; G04G 17/045

(57) ABSTRACT

An electronic device and a wearable device are provided. The electronic device includes a cover plate, a middle frame and a circuit board. The middle frame is provided with a mounting cavity; the middle frame is provided with a mating surface; the middle frame includes an antenna exposed from the mating surface; and the cover plate is stacked on the mating surface and covers the antenna and the mounting cavity. The circuit board is arranged in the mounting cavity and is electrically connected to the antenna. Compared with an antenna in the form of flexible circuit board, the arrangement of the antenna herein can reduce an overall thickness of the electronic device, and can improve the anti-interference and anti-shielding performance of the antenna to enhance the communication performance of the electronic device.

### CROSS-REFERENCE TO RELATED APPLICATIONS

This application is a continuation of International Application No. PCT/CN2021/075014, filed Feb. 3, 2021, which claims priority to Chinese Patent Application No. CN 202010258378.7, filed Apr. 3, 2020, the entire disclosures of which are incorporated herein by reference.

### TECHNICAL FIELD

The present disclosure relates to the technical field of wearable devices, and in particularly to an electronic device and a wearable device.

### DESCRIPTION OF RELATED ART

An existing wearable device, such as a smart watch, is generally provided with an antenna for communication, and the antenna is usually implemented in a form of a flexible circuit board. The antenna in the form of a flexible circuit board is stacked with a display module. However, the antenna in the form of a flexible circuit board has a certain thickness, and thus increases an overall thickness of the wearable device, which is not beneficial for the slim and lightweight design of the wearable device.

### SUMMARY

In view of the shortcomings of the related art, it is necessary to provide an electronic device and a wearable device.

An electronic device is provided, which may include: a cover plate; a middle frame, provided with a mounting cavity and a mating surface, where the middle frame includes an antenna exposed from the mating surface, where the cover plate is stacked on the mating surface and covers the antenna and the mounting cavity; and a circuit board, arranged in the mounting cavity and electrically connected to the antenna.

Another electronic device is provided, which may include: a display module; a middle frame, including a frame body and a support, where the frame body is provided with a mounting cavity, the support is connected to an end of the frame body and has a mating surface, the display module is stacked on the mating surface and covers the mounting cavity, the support includes an antenna exposed from the mating surface, and the mating surface is protruded with respect to the antenna or flush with a side of the antenna facing towards the display module; and a circuit board, arranged in the mounting cavity and electrically connected to the antenna.

A wearable device is provided, which may include: a strap; and the electronic device, including: a middle frame, provided with a mounting cavity, where the middle frame has a mating surface at an end of the mounting cavity, and the mating surface extends around the mounting cavity; an antenna, arranged on the mating surface and extending around the mounting cavity; and a cover plate, stacked on the mating surface and covering the antenna and the mounting cavity, where the strap is connected to the middle frame and configured to allow the electronic device to be worn onto a wrist of a user.

### BRIEF DESCRIPTION OF DRAWINGS

In order to explain embodiments of the present disclosure or technical solutions of the related art more clearly, accompanying drawings used in the description of the embodiments or the related art will be briefly introduced below. It is apparent that the accompanying drawings in the following description are merely some embodiments of the present disclosure, and drawings of other embodiments can be obtained according to these drawings without any creative effort for skilled in the art.

FIG. 1 illustrates a schematic view of a wearable device according to an embodiment of the present disclosure.

FIG. 2 illustrates a schematic view of an electronic device of the wearable device of FIG. 1.

FIG. 3 illustrates a schematic exploded view of the electronic device of the wearable device of FIG. 2.

FIG. 4 illustrates a schematic top view of the electronic device of the wearable device in FIG. 2.

FIG. 5 illustrates a schematic cross-sectional view of the electronic device of the wearable device in FIG. 4 taken along a line A-A.

FIG. 6 illustrates a schematic enlarged schematic view of a portion B of the electronic device of the wearable device in FIG. 5.

FIG. 7 illustrates a schematic view of a support of the electronic device of the wearable device of FIG. 3.

FIG. 8 illustrates a schematic front view of the support of the electronic device of the wearable device of FIG. 7.

FIG. 9 illustrates a schematic right view of the support of the electronic device of the wearable device of FIG. 8.

FIG. 10 illustrates a schematic rear view of the support of the electronic device of the wearable device of FIG. 8.

### DETAILED DESCRIPTION OF EMBODIMENTS

In order to facilitate the understanding of the present disclosure, the present disclosure will be more fully described below with reference to relevant drawings. Even though preferred embodiments of the present disclosure are shown in the accompanying drawings, the present disclosure can be implemented in many different forms and is not limited to the embodiments described herein. These described embodiments are provided for a more thorough and comprehensive understanding of the present disclosure.

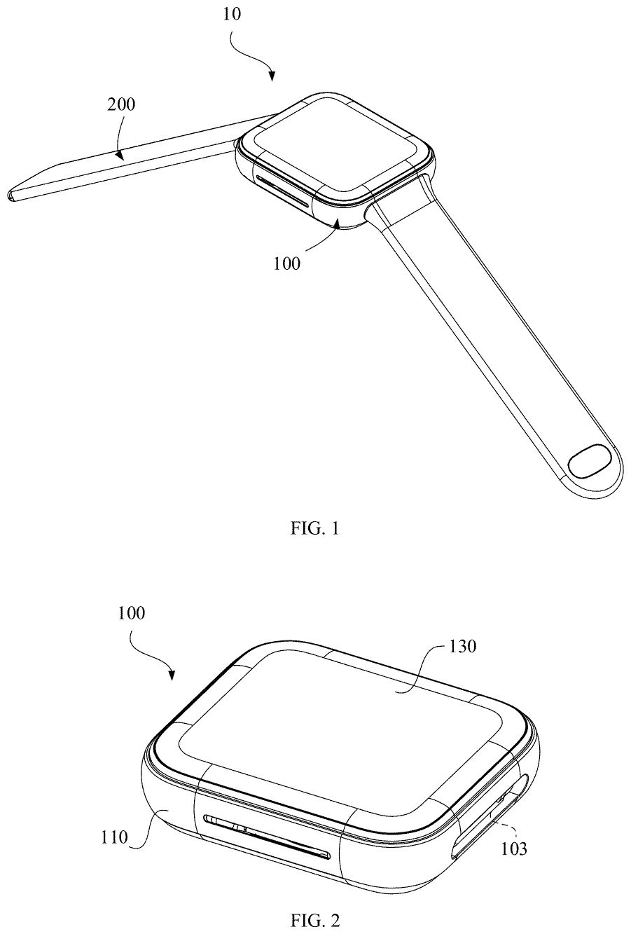

Referring to FIGS. 1, 2 and 3, a wearable device 10 includes an electronic device 100 and a strap 200. The strap 200 is mounted to the electronic device 100 and configured to allow the electronic device 100 to be worn to a wrist of a user. The electronic device 100 includes a middle frame 110 and electronic components such as a circuit board 120 and a battery. The middle frame 110 is provided with a mounting cavity 101. The electronic components such as the circuit board 120 and the battery are disposed in the mounting cavity 101, and the strap 200 is connected to the middle frame 110. In some embodiments, the wearable device 10 may be a smart watch; and the electronic device 100 includes a display module 130, which covers an end of the mounting cavity 101 and is connected to the middle frame 110, and can be configured to display information and provide an interactive interface for the user. The mounting cavity 101 can be configured for mounting electronic components such as the battery, the circuit board 120, the display module 130, and a biosensor. Electronic components such as a processor, a memory unit, and a communication module can be integrated onto circuit board 120. The battery can supply power for the circuit board 120, the display module 130 and other electronic components. Further, the electronic device 100 may include a back cover 140, which is disposed at an end of the middle frame 110 facing away from the display module 130 and covers another end of the mounting cavity 101.

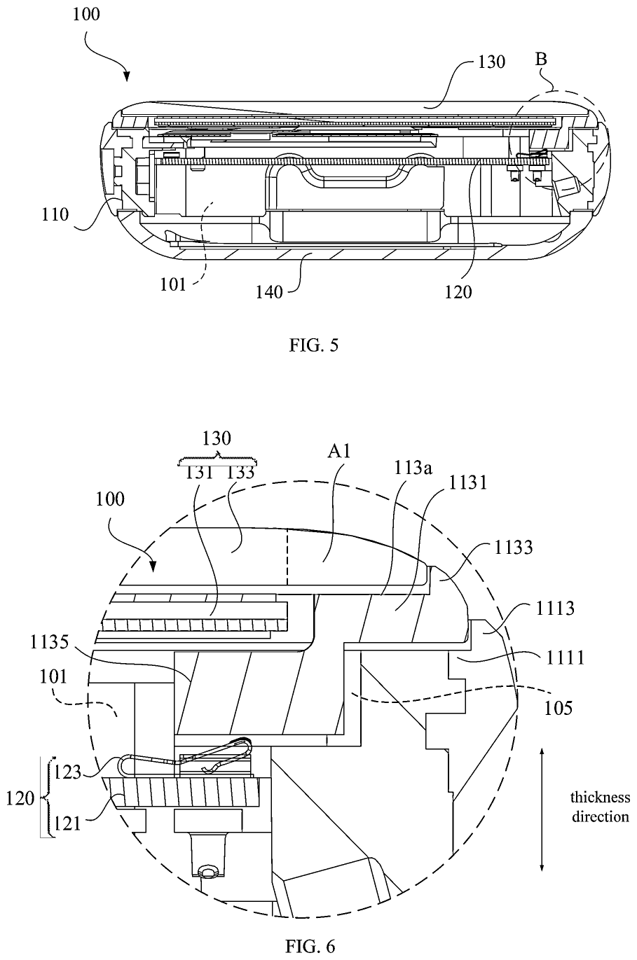

Referring to FIGS. 4, 5 and 6, the display module 130 may further include a display screen 131 and a cover plate 133 covering the display screen 131. The display screen 131 may be a liquid crystal display (LCD) screen or an organic light-emitting diode (OLED) screen. The cover plate may be a glass cover plate 133 or a sapphire cover plate 133. The cover plate 133 is transparent and has a relatively high light transmittance, for example, the light transmittance of the cover plate 133 is above 80%. The display module 130 may have a touch function, but the touch function is not essential. The biosensor can be configured to detect biological data such as a heart rate, a respiration rate, a blood pressure, or body fat. In some embodiments, the biosensor may further configured to detect a motion state, such as for step counting. In some embodiments, the wearable device 10 may be a smart watch or a sports watch, and a common form of the sports watch is an electronic watch. In other embodiments, the wearable device 10 may be a smart bracelet, and the display module 130 may be not essential.

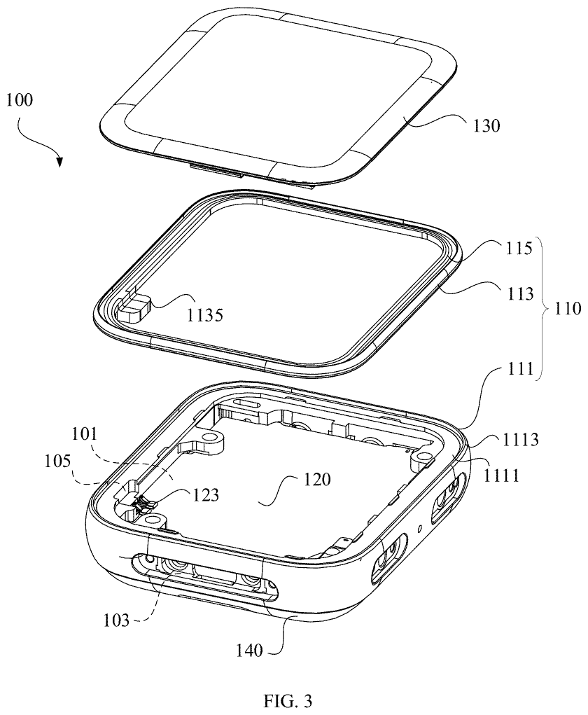

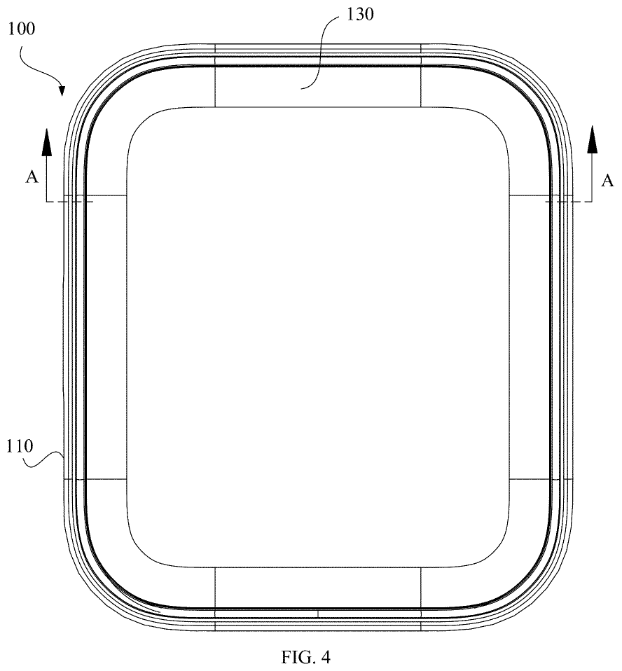

The middle frame 110 is a substantially rectangle. Four corners of the rectangle can be processed by a chamfering process to have circular arcs, such that the wearable device 10 has a better appearance characteristic. In other embodiments, the middle frame 110 may be a circular frame in shape. Referring to FIGS. 2 and 3, a side of the middle frame 110 may be provided with a slot 103 for installing the strap 200. Referring to FIG. 1, the strap 200 is a belt in shape, and can be installed to the middle frame 110 through the slot 103 and can form a reliable connection with the middle frame 110, so as to reliably wear the electronic device 100 to an arm of the user. In some embodiments, the strap 200 can be easily detached from the middle frame 110, so that the strap 200 can be conveniently changed by the user. For example, the user can purchase various styles of straps 200, and change the straps 200 according to usage scenarios to improve the convenience of use. For example, in a formal occasion, the user can use a more formal strap 200 of the straps 200, while in a recreational occasion, the user can use a casual typed strap 200. In some embodiments, the strap 200 is divided into two sections, opposite ends of the electronic device 100 are respectively provided with the slots 103, an end of each of two sections of the strap 200 is connected to the electronic device 100, and ends of the two sections of the strap 200 facing away from the electronic device 100 can be buckled to form an accommodation space, the wearable device 10 can be worn onto the wrist of the user through the strap 200. In other embodiments, the strap 200 can be a one-piece structure, and two ends of the strap 200 are each connected to the electronic device 100. A size of the accommodation space of the strap 200 can be adjusted by other structures, such as a snap ring, a buckle, an elastic expansion, so as to be convenient for the user to wear.

Further, referring to FIG. 3, the middle frame 110 includes a frame body 111, a support 113 and an antenna 115. The support 113 is connected to an end of the frame body 111 and forms a mounting cavity 101 with the frame body 111. Referring to FIGS. 7 and 8, the support 113 is provided with a mating surface 113a, and the display module 130 is stacked on the mating surface 113a and covers an end of the mounting cavity 101. The antenna 115 is located on the support 113 and exposed to the mating surface 113a. The circuit board 120 is electrically connected to the antenna 115, and the circuit board 120 can feed a current into the antenna 115. The frame body 111 may be made of a non-metal material such as plastic, rubber, silica gel, wood, ceramic or glass, or may be made of a metal material such as stainless steel, aluminum alloy or magnesium alloy. Further, the frame body 111 may be a metal injection molded part, that is, a structural rigidity of the frame body 111 is ensured by using a metal material thereof, and an inner surface of the frame body 111 is formed with structures for assembly and positioning such as protrusions, grooves, screw holes by injection molding. It can be understood that the mounting cavity 101 can also be separately formed by the frame body 111, and the support 113 is not essential, and the antenna 115 can be directly located onto the frame body 111. A material of the back cover 140 may be the same as that of the frame body 111, or may be different from that of the frame body 111. For example, the back cover 140 can be made of a non-metal material such as glass, ceramic or plastic, or the back cover 140 can also be made of a metal material such as stainless steel or aluminum alloy.

In some embodiments, the support 113 may be made of a laser direct structuring (LDS) plastic. An antenna receiving slot 113b and the antenna 115 are carved by laser on the mating surface 113a of the support 113, and the antenna 115 is accommodated in and extends along the antenna receiving slot 113b. Specifically, a LDS material contains a metal component and a non-metal component such as a plastic. During the laser carving process, the non-metal component such as the plastic is dissolved and evaporated to form the antenna receiving slot 113b, and the metal component of the LDS material is precipitated and deposited in the antenna receiving slot 113b to form the antenna 115. Since the non-metal material is removed, on a side of the metal antenna 115 facing towards the display module 130, the mating surface 113a is protruded with respect to the antenna 115 or flush with the antenna 115. In other words, a height difference exists between the side of the antenna 115 facing towards the display module 130 and the mating surface 113a, or the side of the antenna 115 facing towards the display module 130 is flush with the mating surface 113a.

In other embodiments, the support 113 may be made of other non-metal material such as silica gel or an ordinary plastic. The support 113 has the mating surface 113a, the mating surface 113a can be provided with the antenna receiving slot 113b, and then the antenna 115 is located in the antenna receiving slot 113b, such that the mating surface 113a protrudes from the antenna or is flush with the antenna 115. The antenna 115 with this structure can reduce an overall thickness of the electronic device 100, which is beneficial to the thin and light design of the electronic device 100.

During an assembly process of the electronic device 100, the mating surface 113a can be formed with an adhesive layer by a dispensing process to reliably connect the display module 130 to the support 113. Compared with the antenna in the form of flexible circuit board, the antenna 115 with the above structure does not increase the overall thickness of the electronic device 100, so it is beneficial to the thin and light design of the electronic device 100, and further beneficial to the thin and light design of the wearable device.

With respect to the electronic device 100, the antenna 115 is exposed to the mating surface 113a of the middle frame 110, and the display module 130 is stacked on the mating surface 113a and covers the antenna 115 and the mounting cavity 101, as such, compared with the antenna in the form of the flexible circuit board, the above antenna 115 can reduce the overall thickness of the electronic device 100. For example, the thickness of the antenna 115 in the form of the flexible circuit board is usually about 0.25 millimeters (mm). Compared with the antenna in the form of flexible circuit board, the overall thickness of the electronic device 100 of the present disclosure can be reduced by 0.25 mm, which is beneficial to the thin and light design of the electronic device 100.

Since the antenna 115 is formed on the support 113, a distance between the antenna 115 and an outer surface of the display module 130 is relatively small after the mating surface 113a is connected to the display module 130. Taking the antenna 115 as a near field communication (NFC) antenna of the electronic device 100 as an example, when the outer surfaces of the display modules of the present disclosure and the related art are at the same distance from radio frequency identification (RFID) readers and other devices, the antenna 115 of the present disclosure can transmit and receive relatively strong signals, and can improve an anti-interference and anti-shielding performance of the antenna 115, so as to improve a communication performance of the electronic device 100. Further, in other embodiments, the antenna 115 can be another typed antenna, such as an antenna for transmitting and receiving cellular signals, and the antenna 115 with the above structure can also improve the communication performance of the electronic device 100.

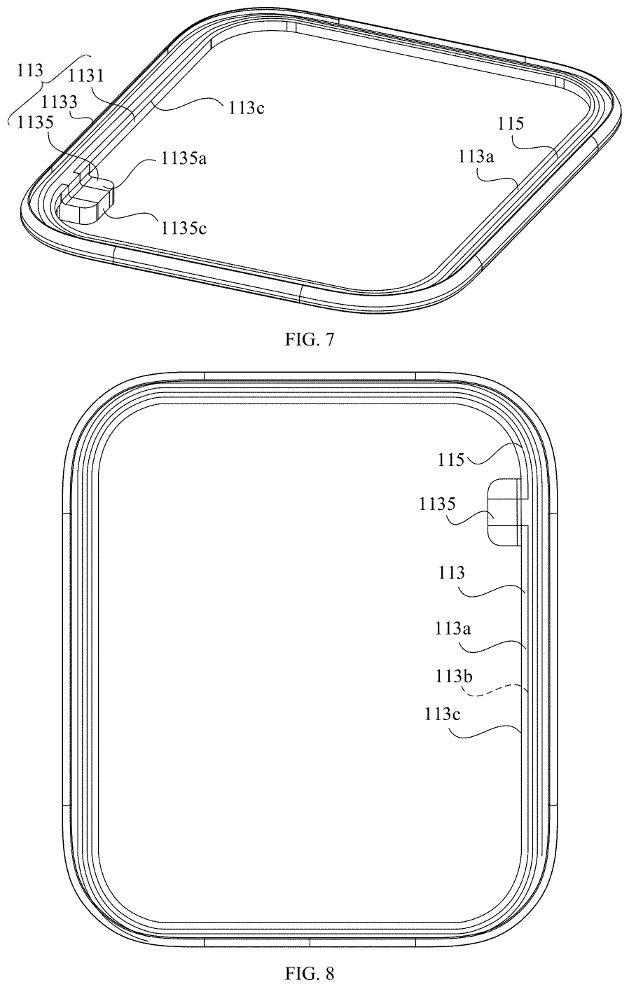

Further, referring to FIGS. 7 and 8, the support 113 is defined with a groove opening 113c of the mounting cavity 101. In an embodiment of the present invention, a cross section of the groove opening 113c is substantially a rounded rectangle, that is, four corners of the rectangle are formed by arc transition. The support 113 is enclosed in a circumferential direction of the groove opening 113c, and the mating surface 113a and the antenna receiving slot 113b extend in the circumferential direction of the groove opening 113c. Further, in some embodiments, the support 113 includes a supporting portion 1131 and a limiting portion 1133 which are integrally formed, and the mating surface 113a and the groove opening 113c are located on the supporting portion 1131, so that a cross section of the support 113 is substantially L-shaped. On a side of the mating surface 113a facing towards the display module 130, the limiting portion 1133 protrudes from the supporting portion 1131 and extends along an edge of the supporting portion 1131 to form a circumferentially enclosed structure. Further, referring to FIG. 6, the limiting portion 1133 is arranged surrounding the display module 130. The arrangement of the limiting portion 1133 facilitates the assembly and positioning of the display module 130 on the support 113. For example, after the adhesive layer is formed on the mating surface 113a, the display module 130 is installed onto the support 113, such that the limiting portion 1133 can limit an edge of the display module 130, and can improve a sealing performance between the display module 130 and the support 113, thereby improving a waterproof and dustproof performance of the electronic device 100. In the embodiment where the mounting cavity 101 is defined by the frame body 111, the groove opening 113c of the support 113 may connect to the mounting cavity 101.

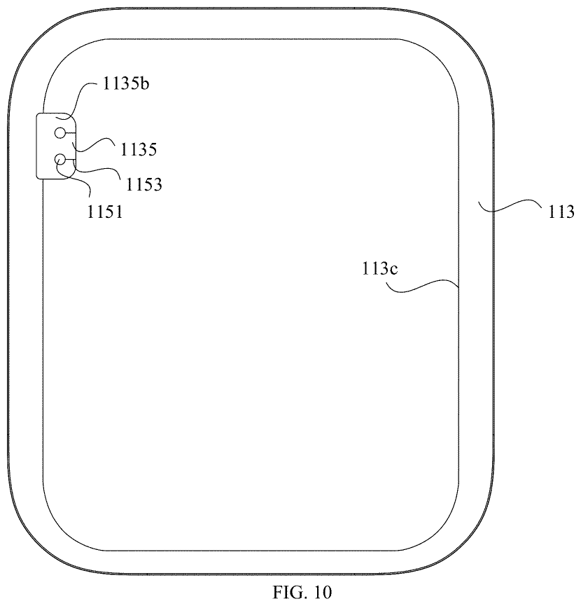

Referring to FIGS. 7, 9 and 10, in some embodiments, the support 113 includes a connecting portion 1135 integrally formed with the supporting portion 1131, and the connecting portion 1135 is protruded into the mounting cavity 101. Further, the connecting portion 1135 is arranged to be protruded from a side wall of the groove opening 113c. A side of the connecting portion 1135 facing away from the display module 130 is provided with a feeding point 1151. The feeding point 1151 is electrically connected to the circuit board 120 and configured for feeding a current into the antenna 115. In some embodiments, the connecting portion 1135 and the support 113 are made of the same material, a LDS plastic. The supporting portion 1131 and the connecting portion 1135 are formed with a connecting wire 1153, which connects the feeding point 1151 and the antenna 115. The feeding point 1151 and the connecting wire 1153 are both formed by the laser carving process, thus simplifying the process of the feeding point 1151 and the connecting wire 1153. Further, referring to FIGS. 7 and 10, the connecting portion 1135 includes a first surface 1135a, a second surface 1135b, and an end surface 1135c connected between the first surface 1135a and the second surface 1135b. The first surface 1135a faces towards the display module 130, the feeding points 1151 are exposed to the second surface 1135b, and the connecting wire 1153 extends along the first surface 1135a and the end surface 1135c to the second surface 1135b and is configured to conduct the feeding points 1151 with the antenna 115. Further, in some embodiments, a height difference exists between the first surface 1135a and the mating surface 113a, which can be used to avoid contact between the limiting portion and the display screen 131, so as to reduce the overall thickness of the electronic device 100.

Further, referring to FIG. 6, the circuit board 120 includes a board body 121 and a resilient component 123 for example, a resilient sheet, disposed on the board body 121. The resilient component 123 protrudes from a side of the board body 121 facing towards the display module 130, and the connecting portion 1135 presses against the resilient component 123, and the feeding point 1151 conducts with the resilient component 123. The arrangement of the resilient component 123 can keep the reliability of the electrical connection between the feeding point 1151 and the circuit board 120, thus ensuring a communication performance of the electronic device 100.

Referring to FIG. 3, in some embodiments, the board body 121 is connected to the frame body 111 with a threaded fastener such as a screw, and the resilient component 123 is two in number, and the two resilient component 123 are arranged at intervals on a side of the board body 121 facing towards the display module 130 and arranged at an edge of the board body 121. The feeding point 1151 is two in number, and the two feeding points 1151 are spaced apart and correspond to the two resilient component 123 by one-to-one correspondence. After the electronic device 100 is assembled and molded, the connecting portion 1135 covers the resilient component 123, and the feeding points 1151 press the resilient components 123 and conduct with the resilient components 123, so that the current of the circuit board 120 can be fed into the antenna 115.

In some embodiments, the antenna 115 is generally annular and distributed on a circumferential edge of the display module 130. Furthermore, after the display module 130 is assembled with the support 113, an edge of the cover plate 133 of the display module 130 is stacked with the mating surface 113a, and the cover plate 133 covers the antenna 115. The display screen 131 of the display module 130 is not stacked with the mating surface 113a, thus preventing the display screen 131 from increasing the overall thickness of the electronic device 100 and weakening a shielding effect of the display screen 131 on the antenna 115. Specifically, referring to FIG. 6, a marginal region A1 is formed between a circumferential edge of the display screen 131 and a circumferential edge of the cover plate 133, and the marginal region A1 covers the antenna 115. In other words, taking a geometric plane perpendicular to a thickness direction of the electronic device 100 as a reference plane, an orthogonal projection of the antenna 115 on the reference plane is located outside of an orthogonal projection of the display screen 131 on the reference plane, that is, the orthogonal projection of the antenna 115 on the reference plane does not overlap with the orthogonal projection of the display screen 131 on the reference plane, that is, the display screen 131 does not cover the antenna 115 in the thickness direction of the electronic device 100.

In the above embodiment, since the display screen 131 does not cover the antenna 115 in the thickness direction of the electronic device 100, there is a relatively small distance between the antenna 115 and an outer surface of the cover plate 133, so that a strength of a signal received or transmitted by the antenna 115 can be improved, and the communication performance of the electronic device 100 can be improved. Taking the antenna 115 as the NFC antenna of the electronic device 100 as an example, when the outer surfaces of the cover plates of the present disclosure and the related art are at the same distance from RFID readers and other devices, the antenna 115 of the present disclosure can transmit and receive relatively strong signals, and can improve the anti-interference and anti-shielding performance of the antenna 115, so as to enhance the communication performance of the electronic device 100.

Further, in other embodiments, in the thickness direction of the electronic device 100, the display screen 131 may cover part or all of the antenna 115, however, since the mating surface 113a protrudes from the antenna 115 or is flush with the side of the antenna 115 facing towards the display module 130, the arrangement of the antenna 115 can also reduce the overall thickness of the electronic device 100, which is beneficial to the thin and light design of the electronic device 100.

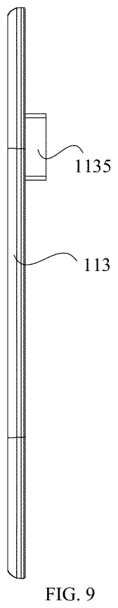

Referring to FIG. 9, in some embodiments, on a side of the supporting portion 1131 facing away from the mating surface 113a, the connecting portion 1135 protrudes relative to the supporting portion 1131. This structural arrangement of the connecting portion 1135 can be configured for the assembly and positioning of the support 113. For example, one of a side of the connecting portion 1135 facing away from the end surface 1135c and a side of the frame body 111 facing towards the connecting portion 1135 may be provided with a groove, and the other of the side of the connecting portion 1135 facing away from the end surface 1135c and the side of the frame body 111 facing towards the connecting portion 1135 may be provided with a protrusion, so that after the support 113 is assembled in the frame body 111, the groove and the protrusion can be engaged with one another, thereby improving connection reliability of the support 113 and the frame body 111. Referring to FIG. 3, for another example, the frame body 111 is provided with a positioning groove 105, the connecting portion 1135 is accommodated in the positioning groove 105, after the support 113 is assembled in the frame body 111, and the positioning groove 105 can limit the movement of the connecting portion 1135, thus bringing out a reliable limiting effect on the connecting portion 1135.

Further, it is not essential that the connecting portion 1135 protrudes from the side of the supporting portion 1131 facing away from the mating surface 113a. For example, the connecting portion 1135 can be omitted, and the antenna 115 can be extended to the side of the supporting portion 1131 facing away from the mating surface 113a by the laser carving process, and then can be electrically connected to the circuit board 120 to feed a current into the antenna 115. For another example, the connecting portion 1135 can be an independent part and fixed to the support 113 by welding, bonding or screwing, and then the antenna 115 is electrically connected to the circuit board 120 through the connecting portion 1135.

Further, referring to FIG. 6 and FIG. 3, the frame body 111 includes an abutting portion 1111 and a stopping portion 1113 connected to the abutting portion 1111. For example, the abutting portion 1111 and the stopping portion 1113 can be integrally formed. The abutting portion 1111 extends along a circumferential direction of the mounting cavity 101 and is configured to support the support 113. The stopping portion 1113 protrudes from a side of the abutting portion 1111 facing towards the display module 130 and extends along an edge of the abutting portion 1111 to form a circumferentially enclosed structure. The support 113 is connected to the abutting portion 1111 and the stopping portion 1113 is arranged surrounding the support 113. In other words, in an embodiment of the present invention, a part of the frame body 111 for assembling with the support 113 is stepped, the support 113 is arranged at the step and the support 113 is surrounded by the stopping portion 1113. The arrangement of the stopping portion 1113 facilitates the assembly and positioning of the support 113 onto the frame body 111. For example, the abutting portion 1111 may be provided with an adhesive layer, and the support 113 can be fixedly connected to the frame body 111 through the adhesive layer, so that the frame body 111 can limit an edge of the support 113, thereby improving a sealing performance between the support 113 and the frame body 111, and further improving a waterproof and dustproof performance of the electronic device 100.

Further, referring to FIG. 6, on a side of the frame body 111 facing towards the display module 130, a tail end of the limiting portion 1133 is protruded with respect to the stopping portion 1113, or the tail end of the limiting portion 1133 is flush with the stopping portion 1113. Furthermore, end surfaces of the limiting portion 1133 and the stopping portion 1113 can be treated with to form curved surfaces, so that the end surfaces of the limiting portion 1133 and the stopping portion 1113 and a surface of the cover plate 133 form a continuous curved profile, thereby improving an appearance characteristic of the electronic device 100.

Technical features of the above-mentioned embodiments can be arbitrarily combined. To make the description concise, all possible combinations of the technical features in the above-mentioned embodiments are not described. However, as long as there is no contradiction in the combination of these technical features, it should be considered as to be fall with the scope of this specification.

The above-mentioned embodiments are merely several embodiments of the present invention, and descriptions thereof are more specific and detailed, but they should not be construed as limiting the scope of protection of the present disclose. It should be pointed out that, for those skilled in the art, without departing from the concept of the present disclosure, several modifications and improvements can be made, all of which belong to the scope of protection of the present disclosure. Therefore, the scope of protection of the present disclosure should be subject to the appended claims.

What is claimed is:

1. An electronic device, comprising:
a cover plate;
a middle frame, provided with a mounting cavity and a mating surface, wherein the middle frame comprises an antenna exposed from the mating surface, the cover plate is stacked on the mating surface and covers the antenna and the mounting cavity; and
a circuit board, arranged in the mounting cavity and electrically connected to the antenna.

2. The electronic device according to claim 1, wherein the middle frame comprises a frame body and a support, the support is connected to an end of the frame body and forms the mounting cavity together with the frame body, the mating surface is located on the support, and the antenna is arranged on the support.

3. The electronic device according to claim 2, further comprising a display screen, wherein the display screen is electrically connected to the circuit board, and the cover plate covers the display screen.

4. The electronic device according to claim 3, wherein a marginal region is formed between a circumferential edge of the display screen and a circumferential edge of the cover plate, and the marginal region covers the antenna.

5. The electronic device according to claim 2, wherein an antenna receiving slot is formed at a side of the support at which the mating surface is located, and the antenna is accommodated in and extends along the antenna receiving slot.

6. The electronic device according to claim 5, wherein the support is made of a laser direct structuring (LDS) plastic.

7. The electronic device according to claim 6, wherein the antenna receiving slot and the antenna are carved by laser on the support.

8. The electronic device according to claim 6, wherein the mating surface is protruded relative to the antenna, or flush with a side of the antenna facing towards the cover plate.

9. The electronic device according to claim 6, wherein the support is defined with a groove opening of the mounting cavity, the support is closed in a circumferential direction of the groove opening, and the mating surface and the antenna receiving slot extend in the circumferential direction of the groove opening.

10. The electronic device according to claim 9, wherein the support comprises a supporting portion and a limiting portion which are integrally formed, the mating surface and the groove opening are located on the supporting portion; on a side of the mating surface facing towards the cover plate, the limiting portion protrudes from the supporting portion and extends along an edge of the supporting portion to form a circumferentially enclosed structure; and the limiting portion is arranged surrounding the cover plate.

11. The electronic device according to claim 10, wherein the frame body comprises an abutting portion and a stopping portion connected to the abutting portion, the abutting portion extends along a circumferential direction of the mounting cavity, the stopping portion protrudes from a side of the abutting portion facing towards the cover plate and extends along the abutting portion to form a circumferentially enclosed structure, the support is connected to the abutting portion, and the stopping portion is arranged surrounding the support.

12. The electronic device according to claim 11, wherein on a side of the frame body facing towards the cover plate, a tail end of the limiting portion is protruded with respect to the stopping portion or the tail end of the limiting portion is flush with the stopping portion.

13. The electronic device according to claim 10, wherein the support comprises a connecting portion integrally formed with the supporting portion, the connecting portion is protruded into the mounting cavity, a side of the connecting portion facing away from the cover plate is provided with a feeding point, and the feeding point is electrically connected to the circuit board and configured for feeding a current into the antenna.

14. The electronic device according to claim 13, wherein the connecting portion comprises a first surface, a second surface opposite to the first surface, and an end surface connected between the first surface and the second surface; the first surface faces towards the cover plate, the feeding point is exposed from the second surface, the support is provided with a connecting wire, and the connecting wire extends along the first surface and the end surface to the second surface and is configured to conduct the feeding point with the antenna.

15. The electronic device according to claim 13, wherein on a side of the supporting portion facing away from the mating surface, the connecting portion protrudes relative to the supporting portion; the frame body is provided with a positioning groove, and the connecting portion is accommodated in the positioning groove.

16. The electronic device according to claim 13, wherein the circuit board comprises a board body and a resilient component disposed on the board body, the resilient component protrudes from a side of the board body facing towards the cover plate, and the connecting portion presses against the resilient component and conducts with the resilient component.

17. An electronic device, comprising:
a display module;
a middle frame, comprising a frame body and a support, wherein the frame body is provided with a mounting cavity, the support is connected to an end of the frame body and has a mating surface, the display module is stacked on the mating surface and covers the mounting cavity, the support comprises an antenna exposed from the mating surface, and the mating surface is protruded with respect to the antenna or flush with a side of the antenna facing towards the display module; and
a circuit board, arranged in the mounting cavity and electrically connected to the antenna.

18. The electronic device according to claim 17, wherein the display module comprises a cover plate and a display screen, the cover plate is transparent and covers the display screen, and the cover plate is connected to the mating surface and covers the antenna.

19. The electronic device according to claim 18, wherein an orthogonal projection of the antenna on a reference plane is located outside of an orthogonal projection of the display screen on the reference plane, and the reference plane is a geometric plane perpendicular to a thickness direction of the electronic device.

20. A wearable device, comprising:
a strap;
a middle frame, provided with a mounting cavity, wherein the middle frame has a mating surface at an end of the mounting cavity, and the mating surface extends around the mounting cavity;
an antenna, arranged on the mating surface and extending around the mounting cavity; and
a cover plate, stacked on the mating surface and covering the antenna and the mounting cavity,
wherein the strap is connected to the middle frame and configured to allow the wearable device to be worn onto a wrist of a user.
